(19) United States
(12) Patent Application Publication
(10) Pub. No.: US 2014/0361099 A1
(43) Pub. Date: Dec. 11, 2014

(54) System and Method for Thermal Control of Flow Through a Conduit

(71) Applicant: Finishing Brands Holdings Inc., Minneapolis, MN (US)

(72) Inventors: Daniel F. Marsalek, Toledo, OH (US); Marvin D. Burns, Millbury, OH (US)

(73) Assignee: Finishing Brands Holdings Inc., Minneapolis, MN (US)

(21) Appl. No.: 14/270,097

(22) Filed: May 5, 2014

Related U.S. Application Data
(60) Provisional application No. 61/831,529, filed on Jun. 5, 2013.

(51) Int. Cl. F24H 9/20; B05B 7/22; B05B 7/16

(52) U.S. Cl. CPC F24H 9/2071; B05B 7/1693; B05B 7/22
USPC 239/128; 392/472; 219/494

(57) ABSTRACT

A system including a thermal control hose system, including a flexible hose, a thermal control element within a fluid path of the flexible hose, and a sensor configured to detect a temperature of a fluid traveling through the flexible hose.

### CROSS-REFERENCE TO RELATED APPLICATION

This Application is a Non-Provisional Application and claims priority to U.S. Provisional Patent Application No. 61/831,529, entitled “System and Method for Thermal Control of Flow through a Conduit”, filed Jun. 5, 2013, which is herein incorporated by reference.

### BACKGROUND

The invention relates generally to a system and method for thermal control of flow through a conduit.

Conduits are used in variety of systems to transfer a fluid flow, such as a gas or liquid flow. In many systems, the fluid flow may be heated or cooled before or after passing though the conduit. For example, a first end of the conduit may connect to a heater or cooler separate from the conduit. Unfortunately, a long length of the conduit may result in considerable temperature change from a first end to a second end of the conduit. This may be particularly problematic for various systems, which may rely on a certain temperature range of the fluid flow. For example, a spray device may use airflow to atomize and shape a liquid spray (e.g., paint spray). The temperature of the air may affect the curing and quality of a coating produced from the spray. Unfortunately, the pressurized air fed to the sprayer may vary in temperature during different times of the day and during differing seasons of the year. The change in pressurized air temperature can affect the spraying operations, causing irregularities, deformities, and general non-uniformity in the spray. As a result, the spray may not be applied properly to a target object. Thus, it would be desirable to provide better temperature control of fluid flows, such as liquid or gas flows transferred through conduits.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system including a thermal control hose system, including a flexible hose, a thermal control element within a fluid path of the flexible hose, and a sensor configured to detect a temperature of a fluid traveling through the flexible hose.

In another embodiment, a system including a flexible hose, a heating element within a fluid path of the flexible hose, a heat sensor configured to detect a temperature of a fluid traveling through the flexible hose, and a controller coupled to the sensor and configured to control a power source to increase and decrease heat production by the heating element in response to the temperature detected by the heat sensor.

In another embodiment, a method including controlling a temperature of a fluid flow through a flexible hose via a thermal control element integrated with the flexible hose, wherein the thermal control element is supported directly in a fluid flow path of the flexible hose.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of a temperature controlled hose system;

FIG. 2 is a schematic of an embodiment of a spray system;

FIG. 3 is a schematic of an embodiment of a spray system;

FIG. 4 is a cut away perspective view of an embodiment of a temperature controlled hose;

FIG. 5 is a cut away perspective view of an embodiment of a temperature controlled hose;

FIG. 6 is a cut away perspective view of an embodiment of a temperature controlled hose;

FIG. 7 is a cut away perspective view of an embodiment of a temperature controlled hose;

FIG. 8 is a cut away perspective view of an embodiment of a temperature controlled hose;

FIG. 9 is a cut away perspective view of an embodiment of a temperature controlled hose;

FIG. 10 is a cut away perspective view of an embodiment of a temperature controlled hose;

FIG. 11 is a cut away perspective view of an embodiment of a temperature controlled hose;

FIG. 12 is a cut away perspective view of an embodiment of a temperature controlled hose;

FIG. 13 is a perspective view of an embodiment of a support structure of a temperature controlled hose;

FIG. 14 is a perspective view of an embodiment of a support structure of a temperature controlled hose; and

FIG. 15 is a flowchart of an exemplary method for using the heat hose system and spray systems of FIGS. 1-3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed toward a system and method for adjusting a temperature (e.g., heating or cooling) of a fluid flow to a desired temperature with a flexible thermally controlled hose using sensor feedback. The flexible thermally controlled hose includes a thermal control element capable of changing the temperature of a fluid passing through the flexible thermally controlled hose. For example, the thermal control element may be a heating element (e.g., an electrically resistive wire) or a cooling element (e.g., a conduit within the hose that carries refrigerant, water, etc.). The flexible thermally controlled hose may be used in spraying operations to improve drying times as well as maintain consistent spraying conditions (e.g., consistent viscosity of a coating material). While the flexible thermally controlled hose discussed below may be capable of heating and cooling a fluid flow, the embodiments below will discuss a flexible heated hose with thermal control elements (e.g., heating elements) and/or sensors placed within a fluid flow path.

The flexible heated hose includes sensors and thermal control elements (e.g., heating elements) placed in different position within the fluid flow path (e.g., passage). For example, the heating elements may be supported directly in the flow path away from the wall, or unsupported but still offset and separate from the wall surrounding the fluid flow path (e.g., passage). In some embodiments the thermal control elements (e.g., heating elements) and sensor wires/sensors are in the center of a fluid flow path. In other embodiments, the thermal control elements (e.g., heating elements) and sensing wires/sensors are positioned towards the outside of the fluid flow path. In still other embodiments, the sensor wires/sensors may be placed approximately in the center of the fluid flow path with the thermal control elements (e.g., heating elements) placed towards the outside, or vice versa. In addition to placement within the fluid flow path, the sensing wires and thermal control elements (e.g., heating elements) may be placed at different positions along the length of the flexible temperature controlled hose. For example, the thermal control elements (e.g., heating elements) and/or the sensor(s) may be placed near an end of the flexible temperature controlled hose that couples to a sprayer. In other embodiments, the thermal control elements (e.g., heating elements) may extend along the length of the flexible temperature controlled hose. In operation, the system measures a fluid temperature with sensors coupled to a controller/monitor. The controller/monitor uses the sensor information to control the power supplied to the thermal control elements (e.g., heating elements), and therefore the fluid temperature produced in the flexible temperature controlled hose. Accordingly, the system enables more responsive fluid temperature control for non-continuous spraying operations that happen during different times of the day and in different seasons. It should be understood that the various embodiments shown in the figures and described below may be combined together. For example, the different support structures, heating element arrangements, sensor placement, and sensor wire arrangements may be interchangeable and combinable.

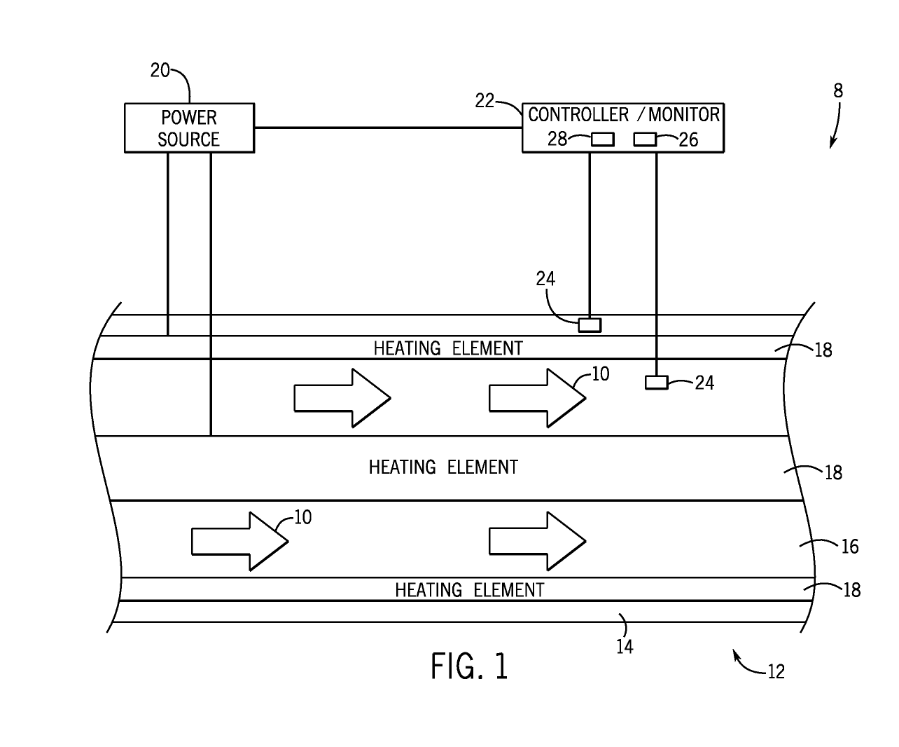

FIG. 1 is a schematic of an embodiment of a heated hose system 8 capable of heating a fluid 10 (e.g., liquid or gas) for different applications (e.g., spraying). The heated hose system 8 includes a flexible heated hose 12 with an outer wall 14 that surrounds a fluid passage 16. The fluid passage 16 enables the fluid 10 to travel through the flexible heated hose 12 from a source to a destination (e.g., a sprayer). Positioned within the fluid passage 16 are heating elements 18, which heat the fluid 10 as it flows through the flexible heated hose 12. The heating elements 18 may be resistive wires that receive electrical current from a power source 20. As the heating elements 18 resist the flow of current from the power source 20, the heating elements 18 increase in temperature. The increase in temperature of the heating elements 18 heats the fluid 10 as it flows through the flexible heated hose 12. Coupled to the power source 20 is a controller/monitoring system 22. The controller/monitoring system 22 controls the amount of power from the power source 20 to the heating elements 18, and therefore how much heat the heating elements 18 produce in the flexible heated hose 12. The controller/monitoring system 22 controls the output of the power source 20 with feedback from sensors 24. The sensors 24 may include a thermocouple, a resistance temperature detector (RTD), an infrared temperature sensor, an optical temperature sensor, or another temperature sensor capable of providing temperature information to the controller/monitoring system 22. In operation, the controller/monitoring system 22 receives the temperature information from the sensors 24 and uses the temperature information to control the power source 20. As illustrated, the controller/monitoring system 22 includes a processor 26 and a memory 28. The memory 28 may store instructions (i.e., software code) executable by the processor 26 to control operation of the heated hose system 8 with feedback from the sensors 24. For example, if the temperature of the fluid 10 in the flexible heated hose 12 is greater than a target temperature as sensed by the sensors 24, the controller/monitor 22 may reduce the amount of power from the power source 20 to the heating elements 18, enabling the fluid to decrease in temperature toward the target temperature. However, if the fluid temperature is less than a target temperature as sensed by the sensors 24, the controller/monitor 22 may increase the power to the heating elements 18, raising the temperature of the fluid 10. Accordingly, the heated hose system 8 enables output of the fluid 10 at the desired temperature for downstream operations (e.g., spraying).

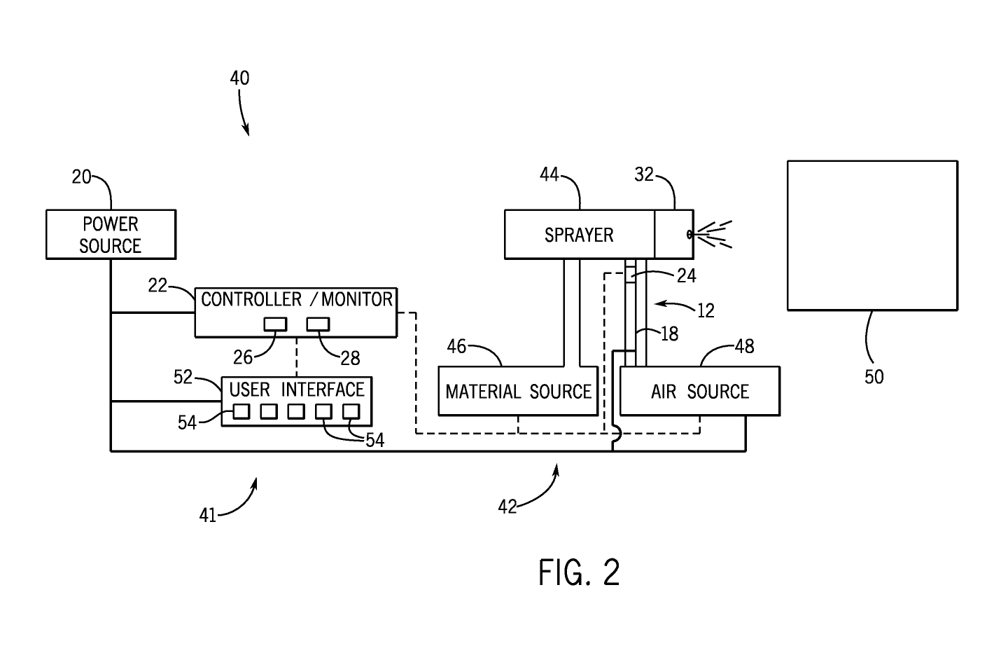

FIG. 2 is a schematic of a spray system 40 with a flexible heated hose 12 that enables consistent spraying conditions (e.g., consistent coating material viscosity) and faster drying times of the coating material. The spray system 40 includes a material delivery system 42, a power source 20, a controller/monitor system 41, and the heated hose 12. These systems operate together to spray a coating material. The material delivery system 42 includes a tool 44 (e.g., spray device), a material source 46 (e.g., tank), and a gas source 48 (e.g., air tank and/or compressor). In operation, the sprayer 44 receives a coating material (e.g., liquid coating material, particulate coating material, etc.) from the material sources 46 that is then sprayed with pressurized gas onto a target 50. In the illustrated example, the tool 44 may be a pneumatic spray gun (e.g., an air spray gun or other gas-driven spray gun).

The spray system 40 may control the spraying operations with the controller/monitoring system 41. The controller/monitoring system 41 includes a controller/monitor 22 and a user interface 52, which may be powered by the power source 20. As illustrated, the controller/monitor 22 includes a processor 26 and a memory 28. The memory 28 may store instructions (i.e., software code) executable by the processor 26 to control operation of the spray system 40. Specifically, the controller/monitor 22 couples to the material delivery system 42 to control various parameters. For example, the controller 22 may control the flow of material from the material source 46, airflow from the airflow source 48, and the heating of the heating elements 18 within the flexible heated hose 12.

The user interface 52 connects to and receives information from the controller/monitor 22. In certain embodiments, the user interface 52 may be configured to allow a user to adjust various settings and operating parameters. Specifically, the user may adjust settings or parameters with a series of buttons or knobs 54 coupled to the user interface 52. In certain embodiments, the user interface 52 may include a touch screen that enables user input and the display of information relating to the spray system 40. For example, the user interface 52 may enable a user to set a desired gas temperature entering the sprayer 44. The controller/monitor 22 may then control the amount of power supplied to heating elements 18 within the flexible heated hose 12 with feedback from the sensors 24. Moreover, the user interface 52 may include preprogrammed operating modes for the spray system 40. These modes may be processes that change the gas temperature for different types of coating materials and/or gases in different spraying operations. For example, an operator may activate one or more operating modes or change the air temperature using a button, knob, dial, or menu 54 on the user interface 52.

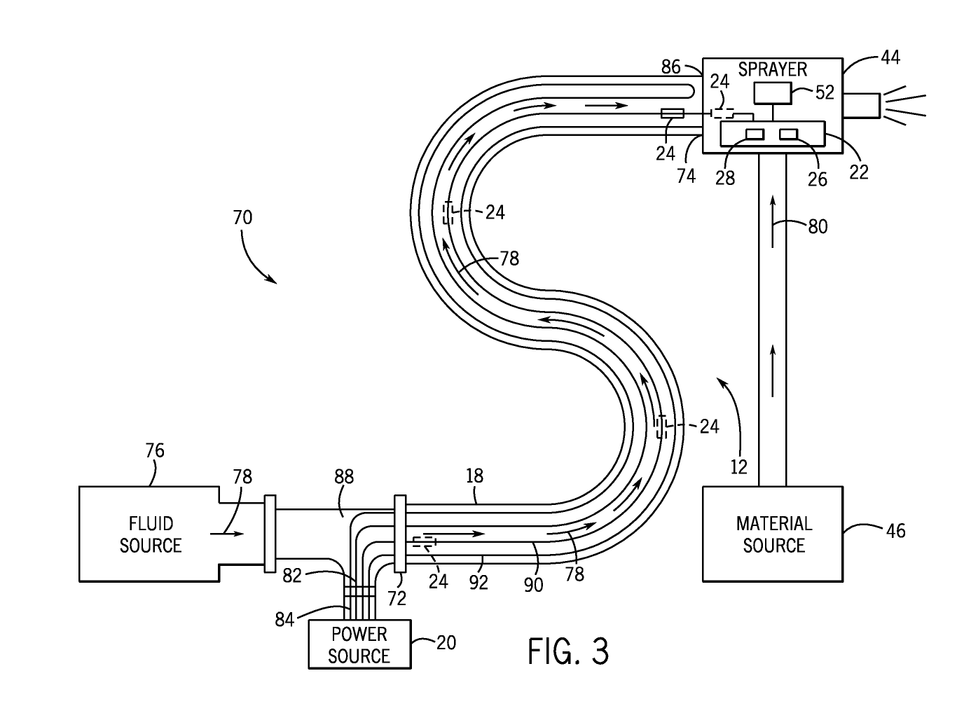

FIG. 3 is a schematic of an embodiment of a spray system 70 with a flexible heated hose 12 that heats a fluid (e.g., gas and/or liquid) to a desired temperature for downstream operations. The fluid may include a gas, such as air, nitrogen, argon, inert gas, or other suitable gas. The flexible heated hose 12 defines a first end 72 and a second end 74. The first end 72 is configured to couple to a fluid source 76, while the second end 74 is configured to couple to the sprayer 44. In this manner, the flexible heated hose 12 enables a fluid 78 to travel from the fluid source 76 to the sprayer 44. As the fluid 78 travels through the flexible heated hose 12, the heating element 18 heats the fluid for use in the sprayer 44. In the sprayer 44, the fluid 78 contacts and sprays a coating material 80 (e.g., paint).

As illustrated, the flexible heated hose 12 includes the heating element 18. The heating element 18 extends lengthwise along the hose 12 from the first end 72 to the second end 74, whereby enabling the flexible heated hose 12 to heat the fluid 78 along the entire length of the flexible heated hose 12. However, in other embodiments, the flexible heated hose 12 may heat the fluid 78 at discreet locations (e.g., via 1, 2, 3, 4, 5, 6, 7, 8, 9, 10, or more heating elements at discrete locations). For example, the flexible heated hose 12 may only heat the fluid near the second end 74. As explained above, the heating element 18 may be a resistive wire that receives power from the power source 20. The resistance of the heating element 18 to the current flow causes the heating element to increase in temperature, which heats the fluid 78 as the fluid 78 moves between the fluid source 76 and the sprayer 44 in the flexible heated hose 12.

The heating element 18 includes a first end 82 and a second end 84. The first end 82 receives power from the power source 20 while the second end 84 connects the heating element 18 to ground. With the second end 84 coupled to ground, the current can flow from the power source 20 through the heating element 18. As illustrated, the heating element 18 has a turnaround point 86 at the second hose end 74, making the first and second ends 82 and 84 of the heating element 18 accessible on one end of the flexible heating hose 12. A T-joint 88 coupled to the flexible heated hose 12 enables the flexible heated hose 12 to couple simultaneously to the fluid source 76 and the power source 20. While the present embodiment illustrates a single winding, other embodiments may include more than one winding (e.g., 1, 2, 3, 4, 5, 6, 7, 8, 9, 10, or more windings) between the first end 72 and the second end 74 of the flexible heated hose 12. In other embodiments, there may be more than one heating element 18 that winds back and forth between the first end 72 and the second end 74 of the flexible heated hose 12.

In the present embodiment, the sprayer 44 includes the controller/monitor 22. With the controller/monitor 22 coupled to the sprayer 44, an operator may select or change the fluid temperature of the fluid 78 entering the sprayer 44 while spraying. The operator may also receive immediate feedback on fluid temperatures in the flexible heated hose 12 with the user interface 52. In other embodiments, the controller/monitor 22 is separate from the sprayer 44. As explained above, the controller/monitor 22 receives feedback on fluid temperatures with sensors 24. The sensors 24 may be placed in the sprayer 44 and/or in the flexible heated hose 12. As illustrated, there may be multiple sensors 24 placed at different locations along the length of the flexible heated hose 12 and/or there may be multiple sensors 24 placed at approximately the same location (e.g., at approximately the second hose end 74). In embodiments with multiple sensors 24, the sensors may be the same or different from one another. For example, all of the sensors 24 may be thermocouples or resistance temperature detectors. In other embodiments, each of the sensors 24 may be different (e.g., thermocouple, resistance temperature detector, optical, infrared). In embodiments with multiple sensors 24, the system 70 provides temperature measurement redundancy and may increase system reliability. In the illustrated embodiments, the sensors 24 receive power from the power source 20 and deliver temperature information to the controller/monitor 22 through lines 90 and 92. With the sensors 24 enabling accurate control of the heated hose 12, the spraying system 70 can produce more consistent spraying conditions (e.g., consistent coating material viscosity) and dry the coating material faster.

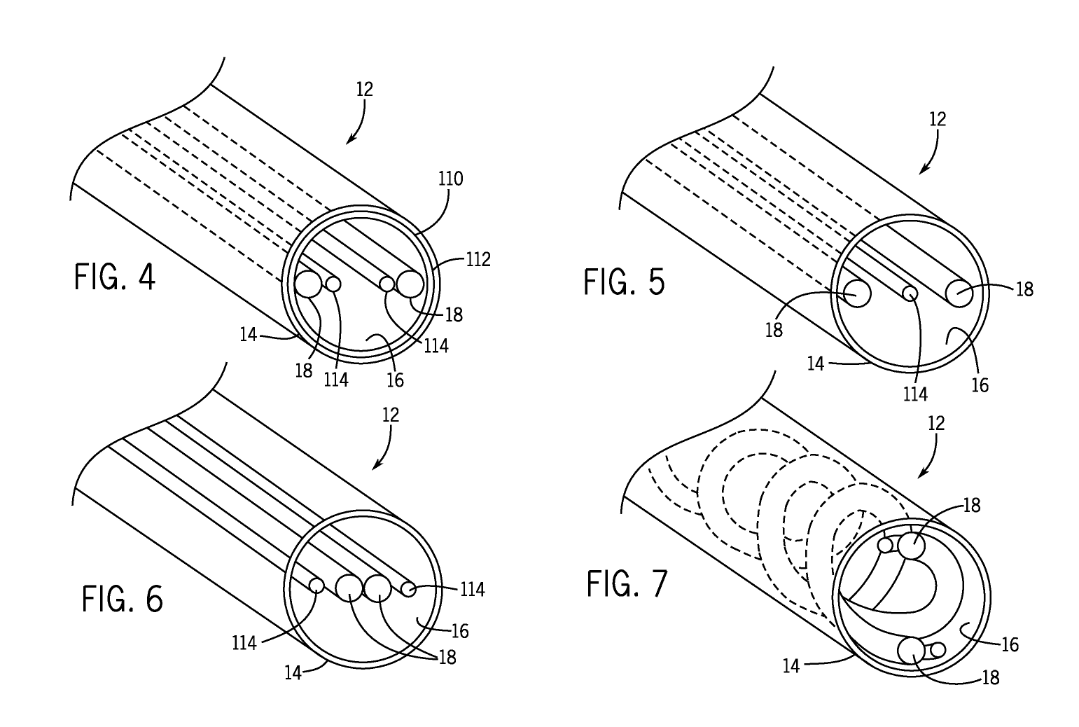

FIG. 4 is a cut away perspective view of an embodiment of a flexible heated hose 12. The flexible heated hose 12 includes the outer wall 14 surrounding the fluid passage 16. The outer wall 14 may be made out of flexible material that is resistant to thermal heat transfer (e.g., rubbers such as Neoprene, EPDM, and Buna; Fluoropolymers such as HDPE, FKM, PVDF; PVC and other vinyls; fabric; plastics such as ethylenes and propylenes; and fiber-glass insulation). The fluid passage 16 enables a fluid to travel through the flexible heated hose 12 from a source to a destination (e.g., a sprayer). Positioned within the fluid passage 16 are heating elements 18, which extend along an axis of and heat the fluid as it flows through the flexible heated hose 12. The heating elements 18 may be resistive wires that receive electrical current from the power source 20. In the present embodiment, the heating elements 18 are positioned proximate an interior surface 110 of the wall 14 providing more space in the center of the flexible heated hose 12 for fluid to travel. However, in certain embodiments the heating elements 18 may be positioned at an offset from the wall 14 to limit or avoid contact between the heating elements 18 and the wall 14, thus limiting thermal conduction between the elements 18 and the wall 14 and increasing the surface area for heat transfer to the fluid. In certain embodiments, the wall 14 may be made of a thermally heat resistance material to reduce heat loss through the wall 14, thereby enabling the fluid to absorb more of the thermal energy produced by the heating elements 18. In some embodiments, the thermal resistance of the flexible hose 12 may increase with the use of a reflective coating or liner 112 along the interior surface 110. The reflective coating or liner may reflect the thermal radiation away from the wall 14, enabling more of the fluid to absorb the thermal energy produced by the heating elements 18. In order to measure the temperature of the fluid within the flexible heated hose 12, the heated hose 12 includes sensor wires 114. The sensor wires 114 couple sensors 24 in the flexible heated hose 12 to the external controller/monitor 22, thereby providing feedback for controlling the heating elements 18. As explained above, the sensors 24 may include a thermocouple, a resistance temperature detector (RTD), an infrared sensor, an optical sensor, etc. capable of providing temperature information. In operation, the controller/monitor 22 receives the temperature information from the sensors 24 and uses the information to control the power source 20.

FIG. 5 is a cut away perspective view of an embodiment of a flexible heated hose 12. In the illustrated embodiment, the sensor wire 114 rests approximately in the center of the fluid passage 16 between the heating elements 114 that are positioned near the wall 14 (e.g., wire sandwiched between elements 18). The sensor wire 114 may be a thermocouple wire capable of measuring the temperature of the fluid at a specific point in the flexible heated hose 12 (e.g., near the second end 74). In the illustrated arrangement, a thermocouple wire may improve the reliability of the fluid temperature measurement. Specifically, by spacing a thermocouple wire away from the heating elements and in the main flow path of the fluid, the thermocouple wire may more accurately reflect the temperature of the fluid flowing through the flexible heated hose 12 and not the temperature of the heating elements 18.

FIG. 6 is a cut away perspective view of an embodiment of a flexible heated hose 12. In the illustrated embodiment, the heating elements 18 are positioned approximately at the center of the fluid passage 16 between the wires 114. This arrangement reduces heat transfer to the wall 14. Instead, the heating elements 18 are able to transmit more thermal energy to the fluid flowing through the flexible heated hose 12 and around the heating elements 18.

FIG. 7 is a cut away perspective view of an embodiment of a flexible heated hose 12. In the illustrated embodiment, the heating elements 18 form one or more coils, spiral-shaped elements, or helical elements that swirl through the flexible heated hose 12. However, in other embodiments, the heating elements 18 may form one or more spirals (e.g., helices). In a spiral arrangement, the heating elements 18 provide a greater surface area per volume or length of the hose 12, thereby increasing the amount of heat transfer per volume or length of the hose 12. The increase in surface area may enable increased and more uniform heating of the fluid flowing through the flexible heated hose 12. A spiral arrangement may also focus the fluid flow towards the center of the fluid passage 16 and away from the wall 14. The less contact between the fluid and the wall 14 may reduce or block the wall 14 from functioning as a heat sink that changes the fluid temperature.

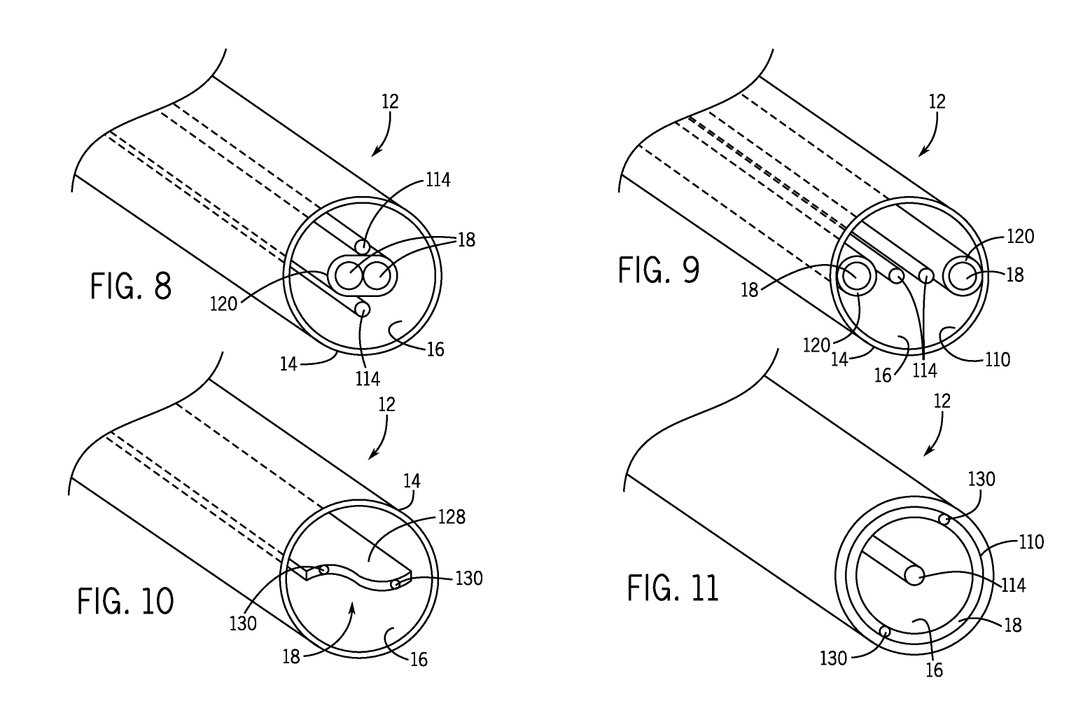

FIG. 8 is a cut away perspective view of an embodiment of a flexible heated hose 12. In the illustrated embodiment, the heating elements 18 are covered in a protective sheath or coating 120. The coating 120 may be made out of a material that effectively conducts heat, but blocks electrical contact between the heating elements 18 (e.g., thin plastic coatings; foil-coated or covered polymers; plastic and paper tapes; paints; and epoxies) and the fluid. In this embodiment, the flexible heated hose 12 may heat a liquid as well as a gas without exposing the heating elements 18 to direct contact with a liquid. Moreover, the placement of the heating elements 18 in the center of the fluid passage 16 reduces radiation and conduction heating of the wall 14. Instead, the heating elements 18 are able to transmit more thermal energy to the fluid flowing through the flexible heated hose 12.

FIG. 9 is a cut away perspective view of an embodiment of a flexible heated hose 12. In the illustrated embodiment, the heating elements 18 are positioned proximate an interior surface 110 of the wall 14 providing more space in the center of the flexible heated hose 12 for fluid to travel. The heating elements 18 are also covered in a protective sheath or coating 120. The coating 120 may be made out of a material that effectively conducts heat, but blocks direct contact between the fluid and the heating elements 18 (e.g., thin plastic coatings; foil-coated or covered polymers; plastic and paper tapes; paints; and epoxies). In this embodiment, the flexible heated hose 12 may heat a liquid as well as a gas without exposing the heating elements 18 to direct contact with a liquid.

FIG. 10 is a cut away perspective view of an embodiment of a flexible heated hose 12. In the illustrated embodiment, the heating element 18 is a ribbon 128. The ribbon 128 may be a one-piece structure that includes resistive wires 130. In operation, the wires 130 heat the ribbon 128 that then heats the fluid flowing through the fluid passage 16. The ribbon 128 may be made out of material with a low thermal resistance (i.e., high thermal conductivity) in order to transmit heat from the resistive wires 130 (e.g., thin plastic coatings; foil-coated or covered polymers; plastic and paper tapes; paints; and epoxies). By covering the resistive wires 130, the ribbon 128 may heat a liquid as well as a gas without exposing the heating elements 18 to direct contact with a liquid. Moreover, the ribbon 128 may provide a larger surface area to more effectively heat the fluid passing through the flexible heated hose 12.

FIG. 11 is a cut away perspective view of an embodiment of a flexible heated hose 12. In the illustrated embodiment, the heating element 18 extends along the wall 14 and surrounds the entire interior surface 110 of the flexible heated hose 12. The heating element 18 may include resistive wires 130. In operation, the wires 130 heat the heating element 18 that then heats the fluid flowing through the fluid passage 16. The heating element 18 may be made out of material with a low thermal resistance (i.e., high thermal conductivity) in order to transmit heat from the resistive wires 130 (e.g., thin plastic coatings; foil-coated or covered polymers; plastic and paper tapes; paints; and epoxies). By covering the resistive wires 130, the heating element 18 may heat a liquid as well as a gas without exposing the heating elements to direct contact with a liquid. Moreover, the heating element 18 may provide a large surface area to more effectively heat the fluid as well as reduce resistance to the flow of the fluid through the flexible heated hose 12.

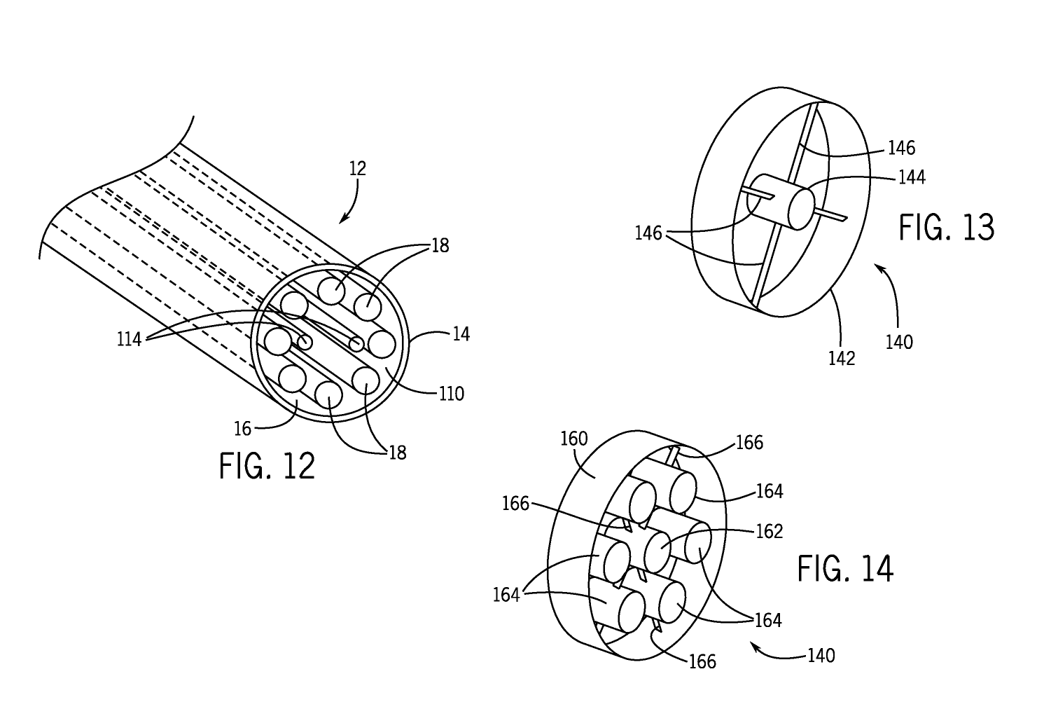

FIG. 12 is a cut away perspective view of an embodiment of a flexible heated hose 12. FIG. 12 illustrates the heating elements 12 (e.g., 1, 2, 3, 4, 5, 6, 7, 8, 9, 10, 25, 50, 75, 100, etc.) arranged in a circular pattern around the interior surface 110. In this arrangement, the heating element(s) 18 may provide a large surface area to more effectively heat the fluid in the flexible heated hose 12. The heating element(s) 18 may be a single resistive wire that winds back and forth between the first end 72 and the second end 74 of the flexible heated hose 12. However, in other embodiments, the hose 12 may include multiple resistive wires to form the heating elements 18. Moreover, in other embodiments, the heating elements 18 may be concentrated in the center instead of near the interior surface 110 of the flexible heated hose 12.

FIG. 13 is a cut away perspective view of an embodiment of a support structure 140 of the hose 12. The support structure 140 enables positioning of the heating elements 18 and/or sensing wires 114 within the fluid passage 16. The support structure 140 includes an outer ring 142 disposed about an inner ring 144 in a generally coaxial or concrete arrangement. The inner ring 144 is supported within the support structure 140 by radial support arms 146. In some embodiments, the inner ring 144 may support a heating element 18, thus positioning the heating element 18 away from wall 14 of the flexible heated hose 12. Furthermore, in some embodiments, at least one heating element 18 may be positioned between the outer ring 142 and the inner ring 144; the sensing wire(s) 114 may be supported within the inner ring 144 or a combination thereof. For example, a thermocouple wire may rest within the inner ring 144 enabling an accurate fluid temperature measurement. The flexible heated hose 12 may include multiple support structures 140 throughout the length of the flexible heated hose 12 to position and support the sensing wires 114 and heating elements 18. Moreover, in certain embodiments, the support structures 140 may be integral to, coupled to, or rest within the flexible heated hose 12.

FIG. 14 is a cut away perspective view of an embodiment of a support structure 140. The support structure 140 enables positioning of the heating elements 18 and/or sensing wires 114 within the fluid passage 16. The support structure 140 includes an outer ring 160, an inner ring 162, and intermediate rings 164 that are circumferentially arranged around the inner ring 162 and in-between the inner ring 162 and the outer ring 160. The inner ring 162 and intermediate rings 164 are supported by support arms 166 that extend from the outer ring 160 to the intermediate rings 164 and then from the intermediate rings 164 to the inner ring 162. The inner ring 162 and intermediate rings 164 may support both heating elements 18 as well as sensing wires 114. For example, the inner ring 162 may support sensing wires 114 while the intermediate rings 164 support heating elements 18, or vice versa. In some embodiments, the inner ring 162 and some of the intermediate rings 164 support heating elements while the remaining intermediate rings 164 support sensing wires 114. The flexible heated hose 12 may include multiple support structures 140 throughout the length of the flexible heated hose 12 to position and support the sensing wires 114 and heating elements 18. Moreover, in certain embodiments, the support structures 140 may be integral to, coupled to, or rest within the flexible heated hose 12.

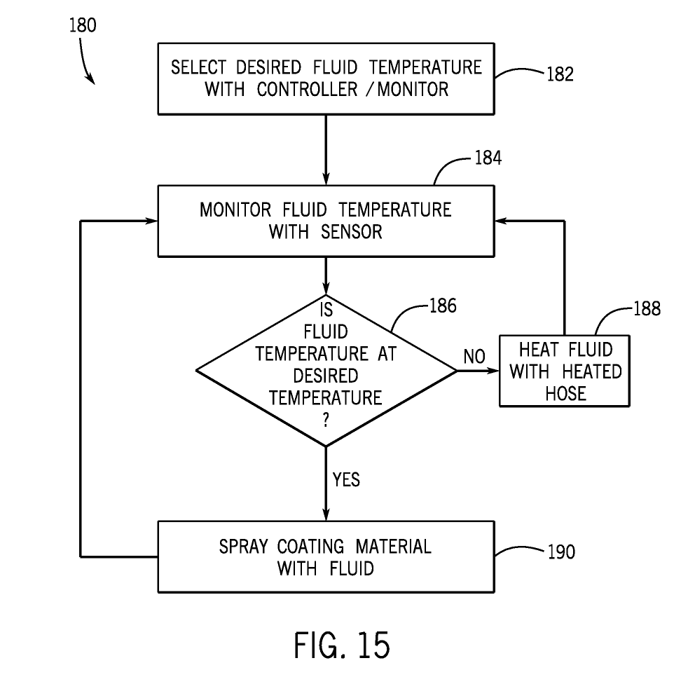

FIG. 15 is a flowchart of an exemplary method 180 for operating the heat hose system 8 and spray systems 40 and 70. The method 180 begins with step 182 by selecting a desired fluid temperature with the controller/monitor 22. The temperature may be specific to spraying a coating material or for spraying in a certain environment. After selecting a desired temperature, the method 180 monitors the fluid temperature in the hose 12 with a sensor 24, as indicated by step 184. The monitoring of the fluid temperature may be performed with a single sensor 24 or with multiple sensors 24 providing redundant temperature measurement. Moreover, the monitoring may occur both before spraying and while spraying to ensure that the fluid temperature is accurate and consistent. While monitoring the fluid temperature, the controller/monitor 22 determines whether the fluid is at the desired temperature, as indicated by step 186. If the fluid temperature is not at the desired temperature, then the method controls the flexible heated hose 12 to heat the fluid as indicated by step 188. While the flexible heated hose 12 heats the fluid, the controller/monitor 22 continues to monitor the fluid temperature by repeating steps 184 and 186. Once the controller/monitor 22 determines that the fluid is at the desired temperature in step 186, the operator may spray the coating material with fluid or continue spraying the coating material, step 190.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a thermal control hose system, comprising:
a flexible hose;
a thermal control element within a fluid path of the flexible hose; and
a sensor configured to detect a temperature of a fluid traveling through the flexible hose.

2. The system of claim 1, comprising a support structure configured to hold the thermal control element and separate the thermal control element from a wall of the flexible hose.

3. The system of claim 1, wherein the thermal control element comprises a heating element, a cooling element, or a combination thereof.

4. The system of claim 1, comprising a controller coupled to the thermal control element and the sensor.

5. The system of claim 1, comprising a sprayer configured to couple to the flexible hose.

6. The system of claim 1, wherein the sensor is a thermocouple, a resistance temperature detector (RTD), an infrared sensor, or optical sensor.

7. The system of claim 1, wherein the thermal control element extends from a first end of the flexible hose to a second end of the flexible hose.

8. The system of claim 7, wherein the thermal control element comprises a resistive heating element with a first heating element end and a second heating element end, and the first and second wire ends exit the first end of the flexible hose.

9. The system of claim 7, wherein the thermal control element spirals within the flexible hose.

10. The system of claim 7, wherein the thermal control element forms a double helix within the flexible hose.

11. The system of claim 7, wherein the thermal control element extends lengthwise along a central region of the flexible hose.

12. The system of claim 7, wherein the thermal control element extends along an interior surface of the flexible hose

13. The system of claim 7, wherein the thermal control element winds back and forth between the first end of the flexible hose and the second end of the flexible hose.

14. The system of claim 7, wherein the thermal control element comprises a ribbon.

15. The system of claim 14, wherein the ribbon extends along an interior surface of the flexible hose.

16. The system of claim 7, wherein the sensor is located near the second end of the flexible hose.

17. A system comprising:
a flexible hose;
a heating element within a fluid path of the flexible hose;
a heat sensor configured to detect a temperature of a fluid traveling through the flexible hose; and
a controller coupled to the sensor and configured to control a power source to increase and decrease heat production by the heating element in response to the temperature detected by the heat sensor.

18. The system of claim 17, wherein the controller is located within a sprayer.

19. The system of claim 17, wherein the flexible hose comprises a first end and a second end, the second end is configured to couple to a sprayer, and the heat sensor is located proximate the second end of the flexible hose.

20. A method, comprising:
controlling a temperature of a fluid flow through a flexible hose via a thermal control element integrated with the flexible hose, wherein the thermal control element is supported directly in a fluid flow path of the flexible hose.
